(19) United States
(12) Patent Application Publication
(10) Pub. No.: US 2014/0138227 A1
(43) Pub. Date: May 22, 2014

(54) ILLUMINATED KEYBOARD

(71) Applicant: PRIMAX ELECTRONICS LTD., Taipei (TW)

(72) Inventor: Chung-Yuan Chen, Taipei (TW)

(73) Assignee: PRIMAX ELECTRONICS LTD., Neihu (TW)

(21) Appl. No.: 13/760,883

(22) Filed: Feb. 6, 2013

(30) Foreign Application Priority Data
Nov. 21, 2012 (TW) 101143405

(51) Int. Cl. H01H 13/705

(52) U.S. Cl. CPC H01H 13/705
USPC 200/5 A

(57) ABSTRACT

An illuminated keyboard includes a key structure, a non-contact sensor board, a light source, a light guide plate, and a light source circuit layer. The non-contact sensor board is used for sensing the key structure. The light source circuit layer is disposed on the non-contact sensor board for driving the light source to emit a light beam. The light guide plate is located at a side of the light source for transferring the light beam from the light source. Since the light source circuit layer is disposed on the non-contact sensor board, the overall height of the illuminated keyboard is reduced. Moreover, since the light source circuit layer is disposed on the non-contact sensor board, the non-contact sensor board and the light source circuit layer have a shared pin. Under this circumstance, the ease of assembling the illuminated keyboard of the present invention is enhanced.

### FIELD OF THE INVENTION

The present invention relates to a keyboard, and more particularly to an illuminated keyboard.

### BACKGROUND OF THE INVENTION

For allowing users to operate keyboards in a dark or dim environment, some keyboards with light sources such as light emitting diodes (LED) have been introduced into the market. The light sources may provide light beams to illuminate the keyboards. The keyboards with the illuminating functions are also referred as illuminated keyboards. By using the illuminated keyboards, the users can easily identify the characters or the symbols marked on the keys of the illuminated keyboards.

FIG. 1 is a schematic cross-sectional view illustrating a conventional illuminated keyboard. As shown in FIG. 1, the conventional illuminated keyboard 10 comprises plural key structures 11, a membrane switch board 12, a backlight module 13, and a base plate 14. For clarification and brevity, only one key structure 11 is shown in FIG. 1. The membrane switch board 12 comprises an upper wiring plate 15, a lower wiring plate 16, and a partition plate 17. The backlight module 13 comprises a light guide plate 18, a flexible circuit board 19, and a light source L.

The key structure 11 is disposed over the membrane switch board 12 to be depressed by the user. When the key structure 11 is depressed, the membrane switch board 12 is electrically conducted to generate a key signal. The detailed structure of the membrane switch board 12 will be illustrated as follows.

In the membrane switch board 12, the upper wiring plate 15 comprises an upper circuit layer 151, and the lower wiring plate 16 comprises a lower circuit layer 161. The upper circuit layer 151 and the lower circuit layer 161 are circuit patterns, which are made of electrically-conductive material. The upper wiring plate 15 is disposed over the lower wiring plate 16. The partition plate 17 comprises plural perforations 171. Moreover, the partition plate 17 is arranged between the upper wiring plate 15 and the lower wiring plate 16 for preventing erroneous contact between the upper wiring plate 15 and the lower wiring plate 16.

As the key structure 11 is depressed, the upper wiring plate 15 is subjected to deformation. Consequently, the upper circuit layer 151 of the upper wiring plate 15 is penetrated through the corresponding perforation 171 of the partition plate 17, and the upper circuit layer 151 of the upper wiring plate 15 is contacted with the lower circuit layer 161 of the lower wiring plate 16. Under this circumstance, the electrical connection between the upper circuit layer 151 and the lower circuit layer 161 results in the key signal.

The backlight module 13 is disposed under the membrane switch board 12 for illuminating the key structure 11. The backlight module 13 comprises the light guide plate 18, the flexible circuit board 19, and the light source L. The flexible circuit board 19 is disposed under the light guide plate 18. Moreover, the flexible circuit board 19 comprises a light source circuit layer (not shown) for driving the light source L. The light source L is disposed on the flexible circuit board 19. The light guide plate 18 is located at a side of the light source L for transferring the light beam which is emitted by the light source L. The base plate 14 is disposed under the backlight module 13 for supporting the key structure 11, the membrane switch board 12 and the backlight module 13.

By means of the light source L and the light guide plate 18, the light beam from the light source L can be uniformly transferred to each key structure 14. Consequently, the illuminated keyboard 10 has the backlighting function, and the number of the light sources L is reduced. Under this circumstance, the illuminated keyboard 10 is power-saving and cost-effective.

However, the conventional illuminated keyboard 10 still has some drawbacks. For example, since the flexible circuit board 19 for driving the light source L has an inherent thickness and needs to be connected with a power source (not shown), the arrangement of the flexible circuit board 19 may increase the overall height of the illuminated keyboard 10. As known, it is difficult to further reduce the thickness of the illuminated keyboard 10. Moreover, since the flexible circuit board 19 should have an additional pin to be connected with the power source, the complexity of assembling the illuminated keyboard 10 is increased.

Therefore, there is a need of providing an improved illuminated keyboard in order to eliminate the above drawbacks.

### SUMMARY OF THE INVENTION

The present invention provides an illuminated keyboard which has reduced thickness and is easily assembled.

In accordance with an aspect of the present invention, there is provided an illuminated keyboard. The illuminated keyboard includes a key structure, a non-contact sensor board, a light source, a light guide plate, and a light source circuit layer. When the key structure is depressed, a key signal is correspondingly triggered. The non-contact sensor board is used for sensing the key structure and generating the key signal. The light source is disposed on the non-contact sensor for emitting a light beam. The light guide plate is located at a side of the light source for transferring the light beam. The light source circuit layer is disposed on the non-contact sensor board for driving the light source.

In an embodiment, the light guide plate and the non-contact sensor board are made of light-transmissible material.

In an embodiment, the light source is a light emitting diode.

In an embodiment, the non-contact sensor board is disposed over or under the light guide plate.

In an embodiment, the key structure includes a keycap, a key base, a conductive element, and an elastic element. The keycap includes a pressing part and a plunger. The key base is used for placing the plunger of the keycap thereon. The conductive element is located at an end of the plunger. The elastic element is disposed under the plunger for allowing the keycap to be returned to an original position.

In an embodiment, the key structure includes a keycap, a scissors-type supporting structure, a conductive element, and an elastic element. The scissors-type supporting structure is used for supporting the keycap. The conductive element is disposed on a bottom surface of the keycap. The elastic element is disposed under the keycap for allowing the keycap to be returned to an original position.

In an embodiment, the key structure includes a conductive element. As the key structure is moved toward the non-contact sensor board, the conductive element is sensed by the non-contact sensor board, and the key signal is generated by the non-contact sensor board.

In an embodiment, the conductive element is a conductive foam structure or a metallic paint film.

In an embodiment, the non-contact sensor board includes a substrate, a first electrode layer, a second electrode layer, and a spacer layer. The first electrode layer is disposed on a surface of the substrate. The second electrode layer is disposed on the surface of the substrate. The spacer layer is arranged between the first electrode layer and the second electrode layer.

In an embodiment, the non-contact sensor board includes a first substrate, a second substrate, a first electrode layer, a second electrode layer, and a spacer layer. The first electrode layer is disposed on a bottom surface of the first substrate. The second electrode layer is disposed on a top surface of the second substrate. The spacer layer is arranged between the first electrode layer and the second electrode layer.

In an embodiment, the non-contact sensor board includes a first substrate, a second substrate, a first electrode layer, a second electrode layer, and a partition plate. The first electrode layer is disposed on a bottom surface of the first substrate. The second electrode layer is disposed on a top surface of the second substrate. The partition plate is arranged between the first substrate and the second substrate.

In an embodiment, the illuminated keyboard further includes a base plate. The base plate is disposed under the light guide plate and the non-contact sensor board for supporting the light guide plate and the non-contact sensor board.

In an embodiment, the illuminated keyboard further includes a reflective plate. The reflective plate is disposed under the light guide plate for reflecting the light beam.

In an embodiment, the illuminated keyboard further includes a reflective layer. The reflective layer is disposed under the light guide plate for reflecting the light beam.

In an embodiment, the key structure further includes a light-outputting region for outputting the light beam.

In an embodiment, the non-contact sensor board includes a first electrode layer, a second electrode layer and a pin. The first electrode layer, the second electrode layer and the light source circuit layer are electrically connected with the pin.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a conventional illuminated keyboard;

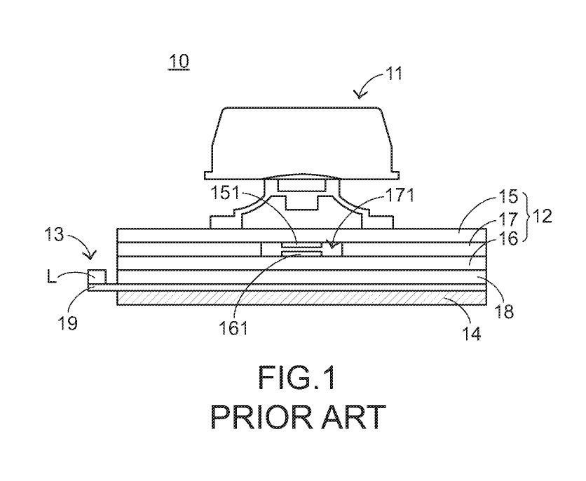

FIG. 2 is a schematic exploded view illustrating an illuminated keyboard according to a first embodiment of the present invention;

FIG. 3 is a schematic perspective view illustrating the keycap of the key structure of the illuminated keyboard as shown in FIG. 2;

FIG. 4 is a schematic exploded view illustrating an illuminated keyboard according to a second embodiment of the present invention;

FIG. 5 is a schematic perspective view illustrating the keycap of the key structure of the illuminated keyboard as shown in FIG. 4;

FIG. 6 is a schematic exploded view illustrating an illuminated keyboard according to a third embodiment of the present invention; and

FIG. 7 is a schematic perspective view illustrating the keycap of the key structure of the illuminated keyboard as shown in FIG. 6.

### DETAILED DESCRIPTION OF THE PREFERRED EMBODIMENT

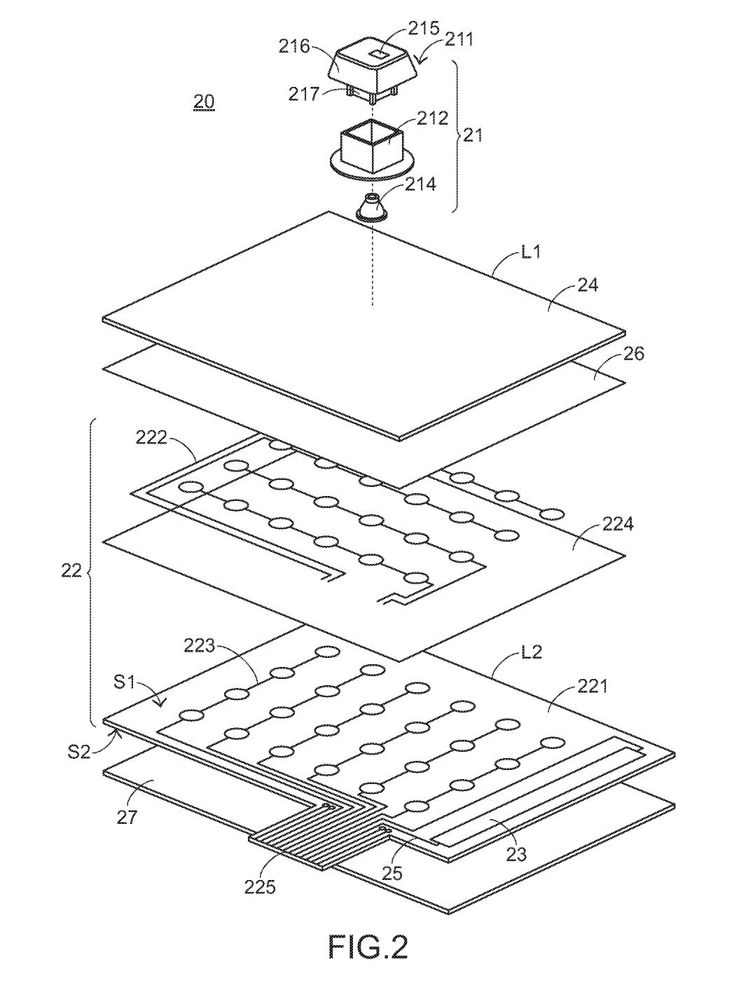

FIG. 2 is a schematic exploded view illustrating an illuminated keyboard according to a first embodiment of the present invention. As shown in FIG. 2, the illuminated keyboard 20 comprises a key structure 21, a non-contact sensor board 22, a light source 23, a light guide plate 24, a light source circuit layer 25, a reflective layer 26, and a base plate 27. When the key structure 21 is depressed, a key signal is correspondingly triggered. The non-contact sensor board 22 is disposed over or under the light guide plate 24 for sensing the key structure 21 and generating the key signal. In this embodiment, the non-contact sensor board 22 is disposed under the light guide plate 24.

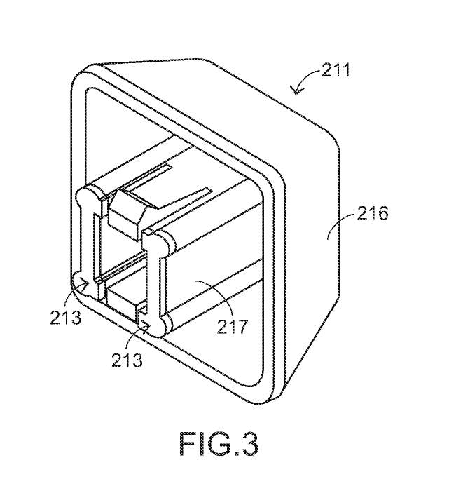

The key structure 21 may be a plunger key structure, a scissors key structure or any other key structure that is known in the art. In this embodiment, the key structure 21 is a plunger key structure. Please also refer to FIG. 3, which is a schematic perspective view illustrating the keycap of the key structure of the illuminated keyboard as shown in FIG. 2. As shown in FIGS. 2 and 3, the key structure 21 comprises a keycap 211, a key base 212, a conductive element 213, an elastic element 214, and a light-outputting region 215. The keycap 211 comprises a pressing part 216 and a plunger 217.

The pressing part 216 is disposed on a top surface of the keycap 211 to be depressed by the user. The plunger 217 is connected with the pressing part 216. In addition, the plunger 217 and the pressing part 216 are linked with each other. The plunger 217 is disposed within the key base 212, and the plunger 217 is movable upwardly or downwardly relative to the key base 212. The elastic element 214 is disposed under the plunger 217. Especially, the elastic element 214 is arranged between the plunger 217 and the light guide plate 24 for providing a restoring force. In response to the restoring force, the keycap 211 is returned to its original position.

The conductive element 213 is located at an end of the plunger 217. In this embodiment, the conductive element 213 is a conductive foam structure or a metallic paint film, but is not limited thereto. The light-outputting region 215 is formed on the keycap 211 for outputting the light beam, thereby facilitating the user to identify the key structure 21. Moreover, the light-outputting region 215 is a light-outputting number region, a light-outputting character region or a light-outputting symbol region. The method of forming the light-outputting region 215 is similar to the method of forming the light-outputting region of the conventional illuminated keyboard, and is not redundantly described herein.

The non-contact sensor board 22 is a touch-sensitive senor board that is enabled in a non-contact manner without the contact between adjacent electrode layers. For example, the non-contact sensor board 22 is a capacitive sensor board or a magnetic sensor board, which is known in the art. In this embodiment, the non-contact sensor board 22 is a single-layered capacitive sensor board, but is not limited thereto.

In this embodiment, the non-contact sensor board 22 comprises a substrate 221, a first electrode layer 222, a second electrode layer 223, a spacer layer 224, and a pin 225. The first electrode layer 222 and the second electrode layer 223 are disposed on a top surface S1 of the substrate 221. The pin 225 is electrically connected with the first electrode layer 222 and the second electrode layer 223. Moreover, the pin 225 is electrically connected with a power source (not shown) for receiving electric power. In addition, the key signal is outputted from the pin 225. It is noted that the positions of the first electrode layer 222 and the second electrode layer 223 may be varied according to the practical requirements. For example, in some other embodiments, both of the first electrode layer 222 and the second electrode layer 223 are disposed on a bottom surface S2 of the substrate 221.

The spacer layer 224 is arranged between the first electrode layer 222 and the second electrode layer 223 in order to prevent from direct contact between the first electrode layer 222 and the second electrode layer 223. The first electrode layer 222 is electrically connected to a positive electrode (not shown), and the second electrode layer 223 is electrically connected to a negative electrode (not shown). Moreover, the distribution of the electric field between the first electrode layer 222 and the second electrode layer 223 may result in a coupling capacitance.

As the pressing part 216 of the key structure 21 is depressed by the user, the key structure 21 is moved toward the non-contact sensor board 22. Correspondingly, the conductive element 213 at the end of the plunger 217 is moved to a position near the non-contact sensor board 22. Under this circumstance, the distribution of the electric field between the first electrode layer 222 and the second electrode layer 223 is changed, and thus a capacitance value between the first electrode layer 222 and the second electrode layer 223 is changed. Due to the change of the capacitance value, the conductive element 213 is sensed by the non-contact sensor board 22, and a corresponding key signal is generated by the non-contact sensor board 22. The sensing principles and the coordinate calculating ways of the non-contact sensor board 22 are similar to those of the conventional capacitive sensor board, and are not redundantly described herein.

Moreover, the light source 23, the light guide plate 24 and the light source circuit layer 25 of the illuminated keyboard 20 can provide the illuminating function of the illuminated keyboard 20 in order to facilitate the user to identify the number, the character or the symbol of the keycap 211. The light source 23 is used for emitting a light beam. In this embodiment, the light source 23 comprises one or more light emitting diodes, but is not limited thereto. In this embodiment, the light source 23 is disposed on the top surface S1 of the substrate 221.

The light guide plate 24 is located at a side of the light source 23 for transferring the light beam, thereby homogenizing the light beam. The light source circuit layer 25 is used for driving the light source 23. The light source circuit layer 25 is electrically connected with the light source 23. Moreover, the light source circuit layer 25 is electrically connected with the pin 225 in order to be connected with the power source. For successfully placing the light guide plate 24 at a side of the light source 23, a rim L1 of the light guide plate 24 is shorter than a corresponding rim L2 of the substrate 221, but is not limited thereto.

For further reducing the overall thickness of the illuminated keyboard 20, the light source 23 and the light source circuit layer 25 are disposed on the non-contact sensor board 22. In this embodiment, the light source circuit layer 25 is disposed on the top surface S1 of the substrate 221. In addition, the light source circuit layer 25, the first electrode layer 222 and the second electrode layer 223 are located at the same side of the substrate 221, but are not limited thereto. In some other embodiments, the light source circuit layer 25 and the first electrode layer 222 and/or the second electrode layer 223 are located at different sides of the substrate 221.

In this embodiment, the spacer layer 224 is made of light-transmissible and insulating material. In addition, the first electrode layer 222, the second electrode layer 223 and the light source circuit layer 25 are made of light-transmissible and electrically-conductive material. An example of the light-transmissible and electrically-conductive material includes but is not limited to indium tin oxide (ITO), nano silver, nano copper, carbon nanotube, or graphene. Moreover, the first electrode layer 222, the second electrode layer 223, the spacer layer 224 and the light source circuit layer 25 are formed by a printing process, a spraying process or an electroplating process, but are not limited thereto.

For allowing the light beam to be transmitted through the keycap 211 to be viewed by the user, the light guide plate 24 and the non-contact sensor board 22 are preferably made of light-transmissible material. An example of the light-transmissible material includes but is not limited to polymethylmethacrylate (PMMA), polycarbonate (PC) or polyethylene terephthalate (PET).

For reducing the leakage percentage of the light beam from the light source 23, the illuminated keyboard 20 further comprises the reflective layer 26. The reflective layer 26 is disposed under the light guide plate 24 for reflecting the portion of the light beam that is transmitted from the bottom of the light guide plate 24. In this embodiment, the reflective layer 26 is formed by performing a screen printing process to print a white ink on the top surface S1 of the substrate 221, so that the function of reflecting the light beam is achievable. It is noted that the way of forming the reflective layer 26 is not restricted.

In some other embodiments, the reflective layer 26 is disposed on a bottom surface of the light guide plate 24. In addition, a buffer layer (not shown) is arranged between the light guide plate 24 and the reflective layer 26 for separating the light guide plate 24 from the reflective layer 26. Due to the buffer layer, the light beam within the light guide plate 24 is subjected to total internal reflection and transferred within the light guide plate 24, and the light beam is not absorbed by the reflective layer 26. Consequently, the efficacy of the total internal reflection can be maintained by the buffer layer. Moreover, it is preferred that the buffer layer is made of a material with low absorptivity and low emissivity to the light beam. Due to the low absorptivity and low emissivity, the adverse influence of the buffer layer on the light-transferring efficacy of the light guide plate 24 will be minimized.

Moreover, the base plate 27 is disposed under the non-contact sensor board 22 and the light guide plate 24 (especially under the non-contact sensor board 22) for supporting the key structure 21, the non-contact sensor board 22 and the light guide plate 24. After the key structure 21, the non-contact sensor board 22 and the light guide plate 24 are fixed on the base plate 27, the illuminated keyboard 20 is fabricated.

In this embodiment, the reflective layer 26 is used to recycle the light beam and the base plate 27 is used to support the key structure 21 and the non-contact sensor board 22. It is noted that the reflective layer and the base plate are not essential components. In some other embodiments, the reflective layer 26 and the base plate 27 are not included the illuminated keyboard 20.

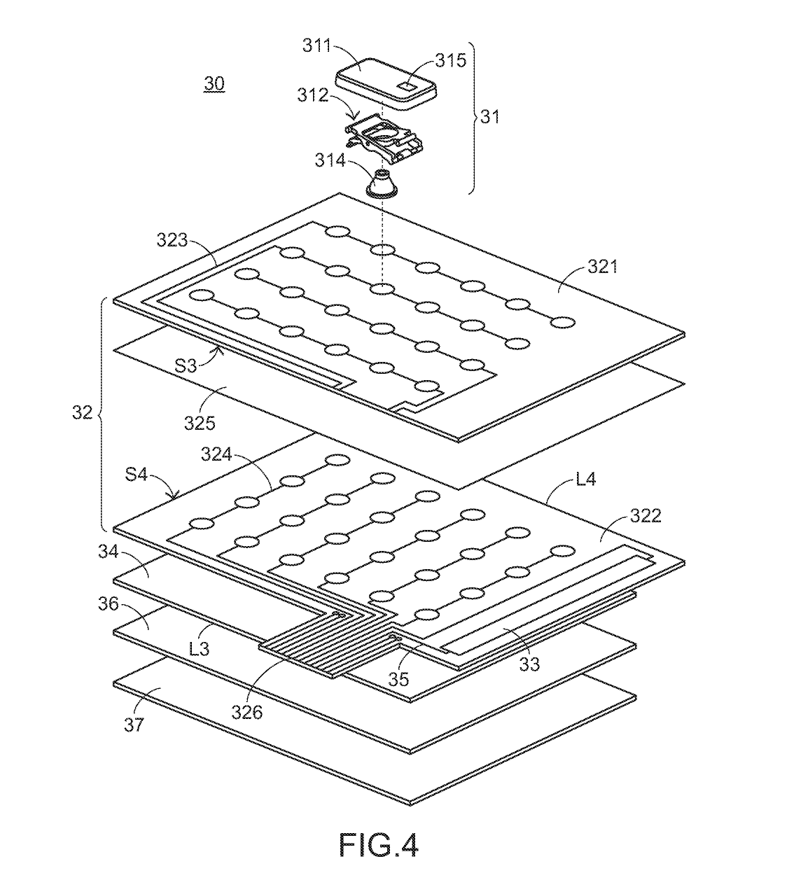

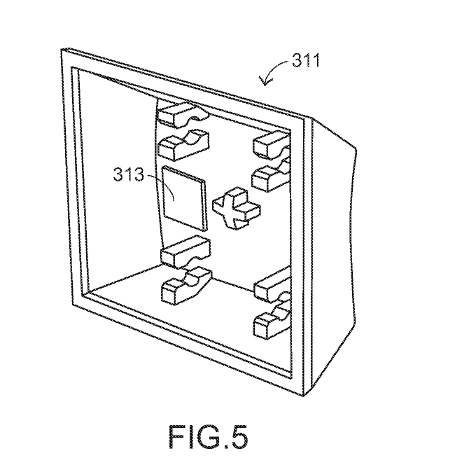

Hereinafter, an illuminated keyboard according to a second embodiment of the present invention will be illustrated with reference to FIGS. 4 and 5.

FIG. 4 is a schematic exploded view illustrating an illuminated keyboard according to a second embodiment of the present invention. As shown in FIG. 4, the illuminated keyboard 30 comprises a key structure 31, a non-contact sensor board 32, a light source 33, a light guide plate 34, a light source circuit layer 35, a reflective plate 36, and a base plate 37. When the key structure 31 is depressed, a key signal is correspondingly triggered. The non-contact sensor board 32 is disposed over or under the light guide plate 34 for sensing the key structure 31 and generating the key signal. In this embodiment, the non-contact sensor board 32 is disposed over the light guide plate 34.

The key structure 31 may be a plunger key structure, a scissors key structure or any other key structure that is known in the art. In this embodiment, the key structure 31 is a scissors key structure. Please also refer to FIG. 5, which is a schematic perspective view illustrating the keycap of the key structure of the illuminated keyboard as shown in FIG. 4. As shown in FIGS. 4 and 5, the key structure 31 comprises a keycap 311, a scissors-type supporting structure 312, a conductive element 313, an elastic element 314, and a light-outputting region 315. The scissors-type supporting structure 312 is disposed under the keycap 311 for supporting the keycap 311. The elastic element 314 is disposed under the keycap 311. Especially, the elastic element 314 is arranged between the keycap 311 and the non-contact sensor board 32 for providing a restoring force. In response to the restoring force, the keycap 311 is returned to its original position.

The conductive element 313 is disposed on a bottom surface of the keycap 311. In this embodiment, the conductive element 313 is a conductive foam structure or a metallic paint film, but is not limited thereto. The light-outputting region 315 is formed on the keycap 311 for outputting the light beam in order to facilitate the user to identify the key structure 31. Moreover, the light-outputting region 315 is a light-outputting number region, a light-outputting character region or a light-outputting symbol region. The method of forming the light-outputting region 315 is similar to the method of forming the light-outputting region of the conventional illuminated keyboard, and is not redundantly described herein.

The non-contact sensor board 32 is a touch-sensitive senor board that is enabled in a non-contact manner without the contact between adjacent electrode layers. For example, the non-contact sensor board 32 is a capacitive sensor board or a magnetic sensor board, which is known in the art. In this embodiment, the non-contact sensor board 32 is a double-layered capacitive sensor board, but is not limited thereto.

In this embodiment, the non-contact sensor board 32 comprises a first substrate 321, a second substrate 322, a first electrode layer 323, a second electrode layer 324, a spacer layer 325, and a pin 326. The first electrode layer 323 is disposed on a bottom surface S3 of the first substrate 321. The second electrode layer 324 is disposed on a top surface S4 of the second substrate 322. The pin 326 is electrically connected with the first electrode layer 323 and the second electrode layer 324. Moreover, the pin 326 is electrically connected with a power source (not shown) for receiving electric power. In addition, the key signal is outputted from the pin 326. It is noted that the positions of the first electrode layer 323 and the second electrode layer 324 may be varied according to the practical requirements. For example, in some other embodiments, the first electrode layer 323 is disposed on the top surface S4 of the second substrate 322, and the second electrode layer 324 is disposed on the bottom surface S3 of the first substrate 321.

The spacer layer 325 is arranged between the first electrode layer 323 and the second electrode layer 324 in order to prevent from direct contact between the first electrode layer 323 and the second electrode layer 324. In this embodiment, the spacer layer 325 is disposed on the bottom surface S3 of the first substrate 321 and disposed under the first electrode layer 323. It is noted that the position of the spacer layer 325 is not restricted. Alternatively, in some other embodiments, the spacer layer 325 is disposed on the top surface S4 of the second substrate 322, and disposed over the second electrode layer 324. The first electrode layer 323 is electrically connected to a positive electrode (not shown), and the second electrode layer 324 is electrically connected to a negative electrode (not shown). Moreover, the distribution of the electric field between the first electrode layer 323 and the second electrode layer 324 may result in a coupling capacitance.

As the key structure 31 is depressed by the user, the key structure 31 is moved toward the non-contact sensor board 32. Correspondingly, the conductive element 313 on the bottom surface of the keycap 311 is moved to a position near the non-contact sensor board 32. Under this circumstance, the distribution of the electric field between the first electrode layer 323 and the second electrode layer 324 is changed, and thus a capacitance value between the first electrode layer 323 and the second electrode layer 324 is changed. Due to the change of the capacitance value, the conductive element 313 is sensed by the non-contact sensor board 32, and a corresponding key signal is generated by the non-contact sensor board 32. The sensing principles and the coordinate calculating ways of the non-contact sensor board 32 are similar to those of the conventional capacitive sensor board, and are not redundantly described herein.

Moreover, the light source 33, the light guide plate 34 and the light source circuit layer 35 of the illuminated keyboard 30 can provide the illuminating function of the illuminated keyboard 30 in order to facilitate the user to identify the number, the character or the symbol of the keycap 311. The light source 33 is used for emitting a light beam. In this embodiment, the light source 33 comprises one or more light emitting diodes, but is not limited thereto. In this embodiment, the light source 33 is disposed on the second substrate 322, and the light-emitting part (not shown) of the light source 33 is penetrated downwardly through the second substrate 322. Consequently, the light-emitting part of the light source 33 is located at a side of the light guide plate 34.

The light guide plate 34 is located at a side of the light source 33 for transferring the light beam, thereby homogenizing the light beam. The light source circuit layer 35 is used for driving the light source 33. The light source circuit layer 35 is electrically connected with the light source 33. Moreover, the light source circuit layer 35 is electrically connected with the pin 326 in order to be connected with the power source. For successfully placing the light guide plate 34 at a side of the light source 33, a rim L3 of the light guide plate 34 is shorter than a corresponding rim L4 of the second substrate 322, but is not limited thereto.

For further reducing the overall thickness of the illuminated keyboard 30, the light source 33 and the light source circuit layer 35 are disposed on the non-contact sensor board 32. In this embodiment, the light source circuit layer 35 is disposed on the top surface S4 of the second substrate 322. In addition, the light source circuit layer 35 and the second electrode layer 324 are located at the same side of the second substrate 322. In some other embodiments, the light source circuit layer 35 and the first electrode layer 323 are located at the same side of the first substrate 321, but are not limited thereto.

In this embodiment, the spacer layer 325 is made of light-transmissible and insulating material. In addition, the first electrode layer 323, the second electrode layer 324 and the light source circuit layer 35 are made of light-transmissible and electrically-conductive material. An example of the light-transmissible and electrically-conductive material includes but is not limited to indium tin oxide (ITO), nano silver, nano copper, carbon nanotube, or graphene. Moreover, the first electrode layer 323, the second electrode layer 324, the spacer layer 325 and the light source circuit layer 35 are formed by a printing process, a spraying process or an electroplating process, but are not limited thereto.

For allowing the light beam to be transmitted through the keycap 311 to be viewed by the user, the light guide plate 34 and the non-contact sensor board 32 are preferably made of light-transmissible material. An example of the light-transmissible material includes but is not limited to polymethylmethacrylate (PMMA), polycarbonate (PC) or polyethylene terephthalate (PET).

For reducing the leakage percentage of the light beam from the light source 33, the illuminated keyboard 30 further comprises the reflective plate 36. The reflective plate 36 is disposed under the light guide plate 34. Especially, the reflective plate 36 is arranged between the light guide plate 34 and the base plate 37 for reflecting the portion of the light beam that is transmitted from the bottom of the light guide plate 34. If the base plate 37 is made of light-transmissible material, the reflective plate 36 is disposed under the light guide plate 34 and the base plate 37.

Moreover, the base plate 37 is disposed under the non-contact sensor board 32 and the light guide plate 34 (especially under the reflective plate 36) for supporting the key structure 31, the non-contact sensor board 32, the light guide plate 34 and the reflective plate 36. After the key structure 31, the non-contact sensor board 32, the light guide plate 34 and the reflective plate 36 are fixed on the base plate 37, the illuminated keyboard 30 is fabricated.

In this embodiment, the reflective plate 36 is used to recycle the light beam and the base plate 37 is used to support the key structure 31 and the non-contact sensor board 32. It is noted that the reflective plate and the base plate are not essential components. In some other embodiments, the reflective plate 36 and the base plate 37 are not included in the illuminated keyboard 30. Alternatively, in some other embodiments, the reflective plate 36 and the base plate 37 are integrally formed as a body plate. Alternatively, in some other embodiments, the surface of the base plate 37 is coated with reflective paint, so that the base plate 37 has the function of reflecting the light beam.

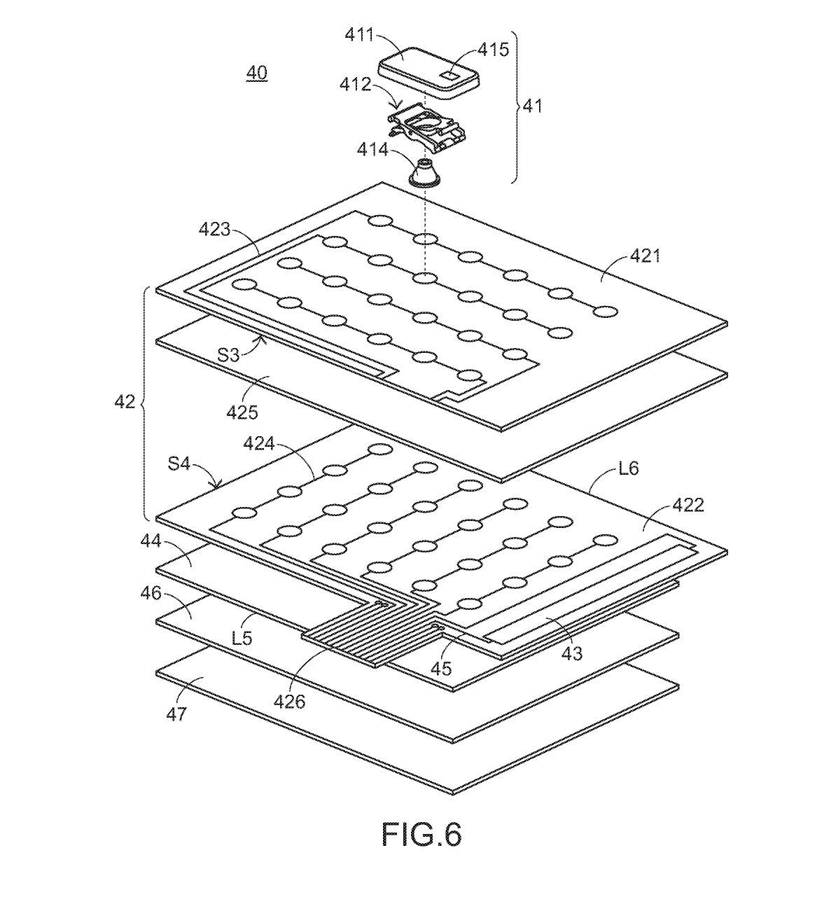

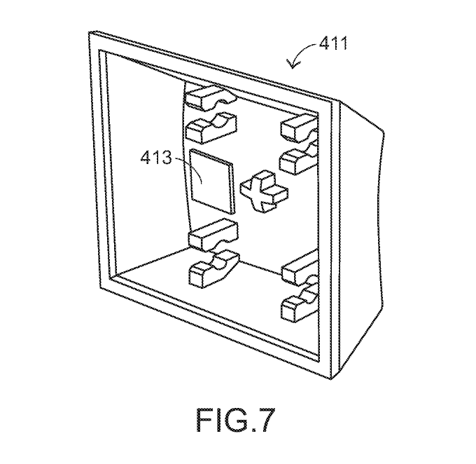

Hereinafter, an illuminated keyboard according to a third embodiment of the present invention will be illustrated with reference to FIGS. 6 and 7.

FIG. 6 is a schematic exploded view illustrating an illuminated keyboard according to a third embodiment of the present invention. As shown in FIG. 6, the illuminated keyboard 40 comprises a key structure 41, a non-contact sensor board 42, a light source 43, a light guide plate 44, a light source circuit layer 45, a reflective plate 46, and a base plate 47. When the key structure 41 is depressed, a key signal is correspondingly triggered. The non-contact sensor board 42 is disposed over or under the light guide plate 44 for sensing the key structure 41 and generating the key signal. In this embodiment, the non-contact sensor board 42 is disposed over the light guide plate 44.

The key structure 41 may be a plunger key structure, a scissors key structure or any other key structure that is known in the art. In this embodiment, the key structure 41 is a scissors key structure. Please also refer to FIG. 7, which is a schematic perspective view illustrating the keycap of the key structure of the illuminated keyboard as shown in FIG. 6. As shown in FIGS. 6 and 7, the key structure 41 comprises a keycap 411, a scissors-type supporting structure 412, a conductive element 413, an elastic element 414, and a light-outputting region 415. The scissors-type supporting structure 412 is disposed under the keycap 411 for supporting the keycap 411. The elastic element 414 is disposed under the keycap 411. Especially, the elastic element 414 is arranged between the keycap 411 and the non-contact sensor board 42 for providing a restoring force. In response to the restoring force, the keycap 411 is returned to its original position.

The conductive element 413 is disposed on a bottom surface of the keycap 411. In this embodiment, the conductive element 413 is a conductive foam structure or a metallic paint film, but is not limited thereto. The light-outputting region 415 is formed on the keycap 411 for outputting the light beam, thereby facilitating the user to identify the key structure 41. Moreover, the light-outputting region 415 is a light-outputting number region, a light-outputting character region or a light-outputting symbol region. The method of forming the light-outputting region 415 is similar to the method of forming the light-outputting region of the conventional illuminated keyboard, and is not redundantly described herein.

The non-contact sensor board 42 is a touch-sensitive senor board that is enabled in a non-contact manner without the contact between adjacent electrode layers. For example, the non-contact sensor board 42 is a capacitive sensor board or a magnetic sensor board, which is known in the art. In this embodiment, the non-contact sensor board 42 is a triple-layered capacitive sensor board, but is not limited thereto.

In this embodiment, the non-contact sensor board 42 comprises a first substrate 421, a second substrate 422, a first electrode layer 423, a second electrode layer 424, a partition plate 425, and a pin 426. The first electrode layer 423 is disposed on a bottom surface S3 of the first substrate 421. The second electrode layer 424 is disposed on a top surface S4 of the second substrate 422. The pin 426 is electrically connected with the first electrode layer 423 and the second electrode layer 424. Moreover, the pin 426 is electrically connected with a power source (not shown) for receiving electric power. In addition, the key signal is outputted from the pin 426. It is noted that the positions of the first electrode layer 423 and the second electrode layer 424 may be varied according to the practical requirements. For example, in some other embodiments, the first electrode layer 423 is disposed on the top surface S4 of the second substrate 422, and the second electrode layer 424 is disposed on the bottom surface S3 of the first substrate 421.

The partition plate 425 is arranged between the first substrate 421 and the second substrate 422 in order to prevent from direct contact between the first electrode layer 423 and the second electrode layer 424. The first electrode layer 423 is electrically connected to a positive electrode (not shown), and the second electrode layer 424 is electrically connected to a negative electrode (not shown). Moreover, the distribution of the electric field between the first electrode layer 423 and the second electrode layer 424 may result in a coupling capacitance.

As the key structure 41 is depressed by the user, the key structure 41 is moved toward the non-contact sensor board 42. Correspondingly, the conductive element 413 on the bottom surface of the keycap 411 is moved to a position near the non-contact sensor board 42. Under this circumstance, the distribution of the electric field between the first electrode layer 423 and the second electrode layer 424 is changed, and thus a capacitance value between the first electrode layer 423 and the second electrode layer 424 is changed. Due to the change of the capacitance value, the conductive element 413 is sensed by the non-contact sensor board 42, and a corresponding key signal is generated by the non-contact sensor board 42. The sensing principles and the coordinate calculating ways of the non-contact sensor board 42 are similar to those of the conventional capacitive sensor board, and are not redundantly described herein.

Moreover, the light source 43, the light guide plate 44 and the light source circuit layer 45 of the illuminated keyboard 40 can provide the illuminating function of the illuminated keyboard 40 in order to facilitate the user to identify the number, the character or the symbol of the keycap 411. The light source 43 is used for emitting a light beam. In this embodiment, the light source 43 comprises one or more light emitting diodes, but is not limited thereto. In this embodiment, the light source 43 is disposed on the second substrate 422, and the light-emitting part (not shown) of the light source 43 is penetrated downwardly through the second substrate 422. Consequently, the light-emitting part of the light source 43 is located at a side of the light guide plate 44.

The light guide plate 44 is located at a side of the light source 43 for transferring the light beam, thereby homogenizing the light beam. The light source circuit layer 45 is used for driving the light source 43. The light source circuit layer 45 is electrically connected with the light source 43. Moreover, the light source circuit layer 45 is electrically connected with the pin 426 in order to be connected with the power source. For successfully placing the light guide plate 44 at a side of the light source 43, a rim L5 of the light guide plate 44 is shorter than a corresponding rim L6 of the second substrate 422.

For further reducing the overall thickness of the illuminated keyboard 40, the light source 43 and the light source circuit layer 45 are disposed on the non-contact sensor board 42. In this embodiment, the light source circuit layer 45 is disposed on the top surface S4 of the second substrate 422. In addition, the light source circuit layer 45 and the second electrode layer 424 are located at the same side of the second substrate 422. In some other embodiments, the light source circuit layer 45 and the first electrode layer 423 are located at the same side of the first substrate 421, but are not limited thereto.

In this embodiment, the partition plate 425 is made of light-transmissible and insulating material. In addition, the first electrode layer 423, the second electrode layer 424 and the light source circuit layer 45 are made of light-transmissible and electrically-conductive material. An example of the light-transmissible and electrically-conductive material includes but is not limited to indium tin oxide (ITO), nano silver, nano Cu, carbon nanotube, or graphene. Moreover, the first electrode layer 423, the second electrode layer 424 and the light source circuit layer 45 are formed by a printing process, a spraying process or an electroplating process, but are not limited thereto.

For allowing the light beam to be transmitted through the keycap 411 to be viewed by the user, the light guide plate 44 and the non-contact sensor board 42 are preferably made of light-transmissible material. An example of the light-transmissible material includes but is not limited to polymethylmethacrylate (PMMA), polycarbonate (PC) or polyethylene terephthalate (PET).

For reducing the leakage percentage of the light beam from the light source 43, the illuminated keyboard 40 further comprises the reflective plate 46. The reflective plate 46 is disposed under the light guide plate 44. Especially, the reflective plate 46 is arranged between the light guide plate 44 and the base plate 47 for reflecting the portion of the light beam that is transmitted from the bottom of the light guide plate 44. If the base plate 47 is made of light-transmissible material, the reflective plate 46 may be disposed under the light guide plate 44 and the base plate 47.

Moreover, the base plate 47 is disposed under the non-contact sensor board 42 and the light guide plate 44 (especially under the reflective plate 46) for supporting the key structure 41, the non-contact sensor board 42, the light guide plate 44 and the reflective plate 46. After the key structure 41, the non-contact sensor board 42, the light guide plate 44 and the reflective plate 46 are fixed on the base plate 47, the illuminated keyboard 40 is fabricated.

In this embodiment, the reflective plate 46 is used to recycle the light beam and the base plate 47 is used to support the key structure 41 and the non-contact sensor board 42. It is noted that the reflective plate and the base plate are not essential components. In some other embodiments, the reflective plate 46 and the base plate 47 are not included in the illuminated keyboard 40. Alternatively, in some other embodiments, the reflective plate 46 and the base plate 47 are integrally formed as a body plate. Alternatively, in some other embodiments, the surface of the base plate 47 is coated with reflective paint, so that the base plate 47 has the function of reflecting the light beam.

From the above descriptions, the present invention provides an illuminated keyboard. A light source and a light source circuit layer for driving the light source are disposed on a non-contact sensor board. In addition, a light guide plate is disposed over or under the non-contact sensor board for transferring a light beam from the light source. Consequently, the flexible circuit board used in the conventional illuminated keyboard is omitted, and the overall height of the illuminated keyboard is reduced. Moreover, since the light source circuit layer and the non-contact sensor board have a shared pin, the illuminated keyboard can be electrically connected with the external device (e.g. a power source) more easily. Under this circumstance, the ease of assembling the illuminated keyboard of the present invention is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An illuminated keyboard, comprising:
a key structure, wherein when said key structure is depressed, a key signal is correspondingly triggered;
a non-contact sensor board for sensing said key structure and generating said key signal;
a light source disposed on said non-contact sensor for emitting a light beam;
a light guide plate located at a side of said light source for transferring said light beam; and
a light source circuit layer disposed on said non-contact sensor board for driving said light source.

2. The illuminated keyboard according to claim 1, wherein said light guide plate and said non-contact sensor board are made of light-transmissible material.

3. The illuminated keyboard according to claim 1, wherein said light source is a light emitting diode.

4. The illuminated keyboard according to claim 1, wherein said non-contact sensor board is disposed over or under said light guide plate.

5. The illuminated keyboard according to claim 1, wherein said key structure comprises:
a keycap comprising a pressing part and a plunger;
a key base for placing said plunger of said keycap thereon;
a conductive element located at an end of said plunger; and
an elastic element disposed under said plunger for allowing said keycap to be returned to an original position.

6. The illuminated keyboard according to claim 1, wherein said key structure comprises:
a keycap;
a scissors-type supporting structure for supporting said keycap;
a conductive element disposed on a bottom surface of said keycap; and
an elastic element disposed under said keycap for allowing said keycap to be returned to an original position.

7. The illuminated keyboard according to claim 1, wherein said key structure comprises a conductive element, wherein as said key structure is moved toward said non-contact sensor board, said conductive element is sensed by said non-contact sensor board, and said key signal is generated by said non-contact sensor board.

8. The illuminated keyboard according to claim 7, wherein said conductive element is a conductive foam structure or a metallic paint film.

9. The illuminated keyboard according to claim 1, wherein said non-contact sensor board comprises:
a substrate;
a first electrode layer disposed on a surface of said substrate;
a second electrode layer disposed on said surface of said substrate; and
a spacer layer arranged between said first electrode layer and said second electrode layer.

10. The illuminated keyboard according to claim 1, wherein said non-contact sensor board comprises:
a first substrate;
a second substrate;
a first electrode layer disposed on a bottom surface of said first substrate;
a second electrode layer disposed on a top surface of said second substrate; and
a spacer layer arranged between said first electrode layer and said second electrode layer.

11. The illuminated keyboard according to claim 1, wherein said non-contact sensor board comprises:
a first substrate;
a second substrate;
a first electrode layer disposed on a bottom surface of said first substrate;
a second electrode layer disposed on a top surface of said second substrate; and
a partition plate arranged between said first substrate and said second substrate.

12. The illuminated keyboard according to claim 1, wherein said illuminated keyboard further comprises a base plate, wherein said base plate is disposed under said light guide plate and said non-contact sensor board for supporting said light guide plate and said non-contact sensor board.

13. The illuminated keyboard according to claim 1, wherein said illuminated keyboard further comprises a reflective plate, wherein said reflective plate is disposed under said light guide plate for reflecting said light beam.

14. The illuminated keyboard according to claim 1, wherein said illuminated keyboard further comprises a reflective layer, wherein said reflective layer is disposed under said light guide plate for reflecting said light beam.

15. The illuminated keyboard according to claim 1, wherein said key structure further comprises a light-outputting region for outputting said light beam.

16. The illuminated keyboard according to claim 1, wherein said non-contact sensor board comprises a first electrode layer, a second electrode layer and a pin, wherein said first electrode layer, said second electrode layer and said light source circuit layer are electrically connected with said pin.
